(19) United States
(12) Patent Application Publication
(10) Pub. No.: US 2011/0205397 A1
(43) Pub. Date: Aug. 25, 2011

(54) PORTABLE IMAGING DEVICE HAVING DISPLAY WITH IMPROVED VISIBILITY UNDER ADVERSE CONDITIONS

(76) Inventors: John Christopher Hahn, Rochester, NY (US); Kelley S. Parsons, North Syracuse, NY (US); Alison Boncha, Rochester, NY (US); Wayne E. Prentice, Honeoye Falls, NY (US); Peter C. Ozug, Rochester, NY (US); Thomas E. Madden, Fairport, NY (US)

(21) Appl. No.: 12/711,452

(22) Filed: Feb. 24, 2010

(51) Int. Cl. H04N 5/225; H04N 5/76

(52) U.S. Cl. 348/231.6; 348/E05.022; 348/E05.024

(57) ABSTRACT

A digital image capture device having a soft-copy display with improved image visibility under adverse viewing conditions, comprising: an image sensor; an optical system; a soft-copy display; a data storage system storing a plurality of color transforms; an environmental sensing means; and a processor for performing the steps of capturing an input digital image; selecting a preview color transform responsive to a signal from the environmental sensing means, wherein a preview color transform that provides improved image visibility is selected for signals from the environmental sensing means corresponding to adverse viewing conditions; transforming the input digital image using the preview color transform to form a preview image; displaying the preview image on the soft-copy display; and recording the input digital image in a processor-accessible memory without using the preview color transform

### FIELD OF THE INVENTION

This invention pertains to the field of viewing digital images on a portable display device, and more particularly to a digital capture device having a display with improved visibility under adverse conditions.

### BACKGROUND OF THE INVENTION

Digital cameras have become very common and have largely replaced traditional film cameras. Today, most digital cameras incorporate an image display screen on the back of the camera. The display screen enables images to be composed as they are being captured, and provides user interface elements for adjusting camera settings. The display screen is also used to browse through images that have been captured and are stored in the digital camera's memory.

In many digital cameras and camera phones, there is no optical viewfinder, and the display screen must be used to compose images to be captured. Therefore, it is critical that the display screen provide images that are visible to the user under a wide range of conditions

The visibility of images on a display screen, such as an LCD, can be limited by adverse viewing conditions, particularly glare from direct sunlight. Therefore, it is very difficult to capture images using these devices under such adverse conditions.

It is known to use various materials in front of the display to minimize glare. For example, U.S. Patent Application Publication 2009/0213593 to Foley et al., entitled “Optical device and system for black level enhancement and methods of use thereof” teaches the use of a microstructure layer for enhancing the contrast of a display. However, using such materials can add significant expense, and even the best materials that have been developed still produce unacceptable glare levels that significantly impact image visibility when displays are used in bright sunlight conditions.

It is also known to provide automatic luminance and contrast adjustment as functions of ambient/surround luminance for a display device, as described in U.S. Pat. No. 6,529,212. This patent teaches an apparatus and method for dynamically modifying both the luminance and contrast of an image as it is displayed on a display in response to changing lighting conditions. Sensors are utilized to continually measure the luminance of the light illuminating the display unit and the display surround luminance. Measurement signals generated by the light sensors are processed to provide display luminance and contrast adjustment control signals that gradually cause the adjustment of the display's luminance and contrast, such that the brightness and contrast perception of the displayed image remains constant under the varying conditions. Similarly, U.S. Pat. No. 7,403,227 to Schinner, entitled “Digital camera that automatically adjusts LCD brightness according to ambient light,” teaches adjusting the brightness of a backlight for an LCD in response to a measured scene level. However, these methods do not work under severe glare light conditions, since it is impossible to increase the luminance to a level that compensates for the ambient level of “glare” from direct sunlight.

It is known to provide user-selectable image modifications, such as processing the images from a color digital camera to produce monochrome images, or to produce more highly color saturated images. The recorded images can be viewed on a display on the digital camera, and will appear as monochrome or highly saturated images. Under some conditions, the processed images may be more visible under adverse conditions. But since the recorded image undergoes the same modification as the displayed image, this does not solve the problem of providing a display with improved visibility under adverse conditions, since it modifies the recorded images and any subsequent viewing of these recorded images under any conditions.

There remains a need for a cost effective and user-friendly method for improving the visibility of images viewed on digital imaging devices under adverse viewing conditions in order to enable effective image composition during the image capture process.

### SUMMARY OF THE INVENTION

The present invention represents a digital image capture device having a soft-copy display with improved image visibility under adverse viewing conditions, comprising:

an image sensor for capturing a digital image;

an optical system for imaging a scene onto the image sensor;

a soft-copy display;

a data storage system storing a plurality of color transforms;

an environmental sensing means; and

a processor for performing the steps of:
capturing an input digital image using the image sensor;
selecting a preview color transform from the plurality of color transforms responsive to a signal from the environmental sensing means, wherein a preview color transform that provides improved image visibility relative to a default preview color transform is selected for signals from the environmental sensing means corresponding to adverse viewing conditions;
transforming the input digital image using the preview color transform to form a preview image;
displaying the preview image on the soft-copy display; and
recording the input digital image in a processor-accessible memory without using the preview color transform

It has the advantage that it provides improved visibility for preview images used for image composition purposes during the capturing of digital images under adverse viewing conditions having a high level of viewing glare. This feature enables users to better compose their images during the image capture process.

It has the additional advantage that it provides improved visibility for digital images when they are viewed under adverse viewing conditions while browsing images in an image reviewing mode.

It has the further advantage that it can be used to supplement methods that involve automatically adjusting the brightness of the soft-copy display responsive to the viewing condition, thus extending the range of viewing conditions under which adequate image visibility can be obtained.

### BRIEF DESCRIPTION OF THE DRAWINGS

FIG. 1 is a high-level diagram showing the components of a prior art digital camera system;

FIG. 2 is a flow diagram depicting typical image processing operations used to process digital images in a digital camera;

FIG. 3 is a flow diagram outlining a method for providing a preview display with improved visibility under adverse conditions according to a preferred embodiment of the present invention;

FIG. 4 is a flow diagram outlining a method for providing a review display with improved visibility under adverse conditions according to a preferred embodiment of the present invention;

FIG. 5 illustrates a rear view of a digital camera which can be used in accordance with the present invention;

FIG. 6A provides a look-up table curve for implementing a contrast transform having no contrast boost;

FIG. 6B provides a look-up table curve for implementing a contrast transform having a moderate contrast boost;

FIG. 6C provides a look-up table curve for implementing a contrast transform having a large contrast boost; and

FIG. 7 illustrates a function that can be used to adjust the display brightness in accordance with the present invention.

It is to be understood that the attached drawings are for purposes of illustrating the concepts of the invention and may not be to scale.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The following description of a digital camera will be familiar to one skilled in the art. It will be obvious that there are many variations of this embodiment that are possible and are selected to reduce the cost, add features or improve the performance of the camera.

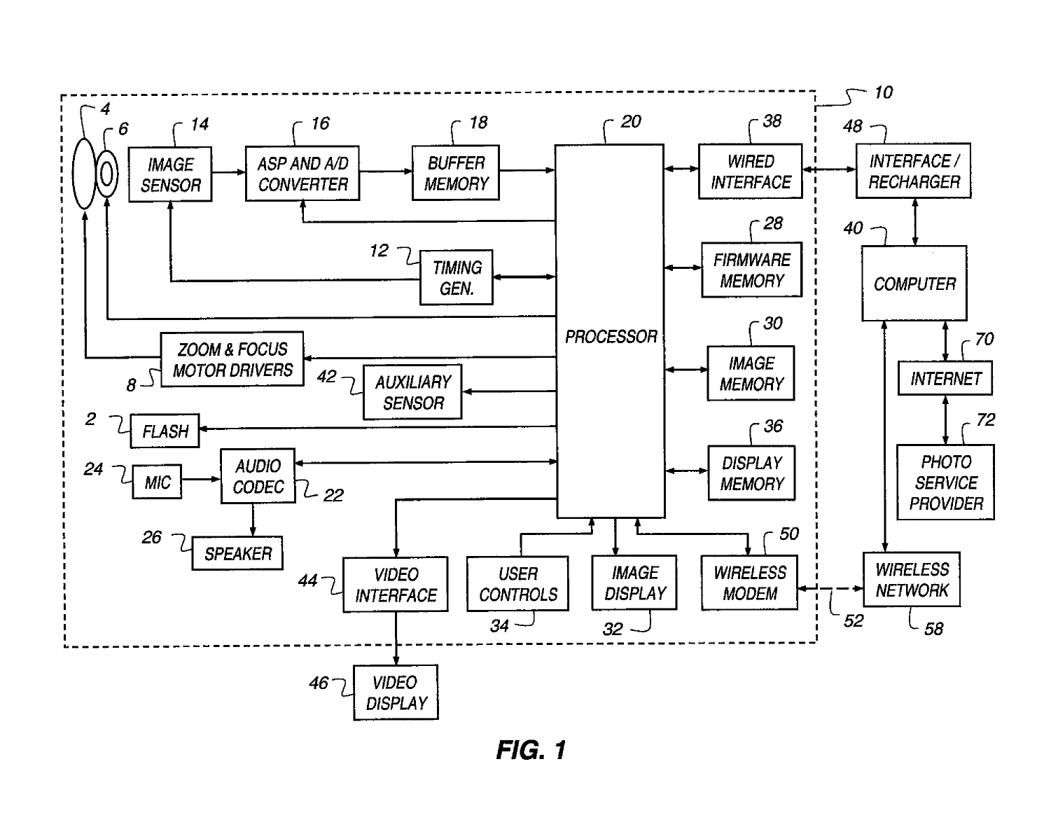

FIG. 1 depicts a block diagram of a digital photography system, including a digital camera 10. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a zoom lens 4 having an adjustable aperture and adjustable shutter 6. The zoom lens 4 is controlled by zoom and focus motor drives 8. The zoom lens 4 focuses light from a scene (not shown) onto an image sensor 14, for example, a single-chip color CCD or CMOS image sensor. In other embodiments, a fixed focal length lens with either variable or fixed focus can be used.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned US patent application number U.S. Patent Application Publication 2005/191729, filed on Jul. 28, 2007 and titled “Image sensor with improved light sensitivity” to Compton and Hamilton, the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene.

An optional auxiliary sensor 42 can be used to sense information about the scene or the viewing environment. For example, the auxiliary sensor 42 can be a light sensor for measuring an illumination level of the scene in order to set the proper exposure level. Alternatively, the auxiliary sensor 42 can be an environmental sensor used to characterize the viewing environment in which images are being viewed on an image display 32. Those skilled in the art will recognize that many other types of auxiliary sensors 42 can also be used.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the color LCD image display 32 is controlled in response to user input provided by user controls 34. The user controls 34 are used to select various camera modes, such as video capture mode, still capture mode, and review mode. The user controls 34 are also used to turn on the camera, control the zoom lens, and initiate the picture taking process. User controls 34 typically include some combination of buttons, rocker switches, joysticks, or rotary dials. In some embodiments, some of the user controls 34 are provided by using a touch screen overlay on the image display 32. In other embodiments, additional status displays or images displays can be used. An audio codec 22 connected to the processor 20 receives an audio signal from a microphone 24 and provides an audio signal to a speaker 26. These components can be to record and playback an audio track, along with a video sequence or still image. If the digital camera 10 is a multi-function device such as a combination camera and mobile phone, the microphone 24 and the speaker 26 can be used for telephone conversation.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

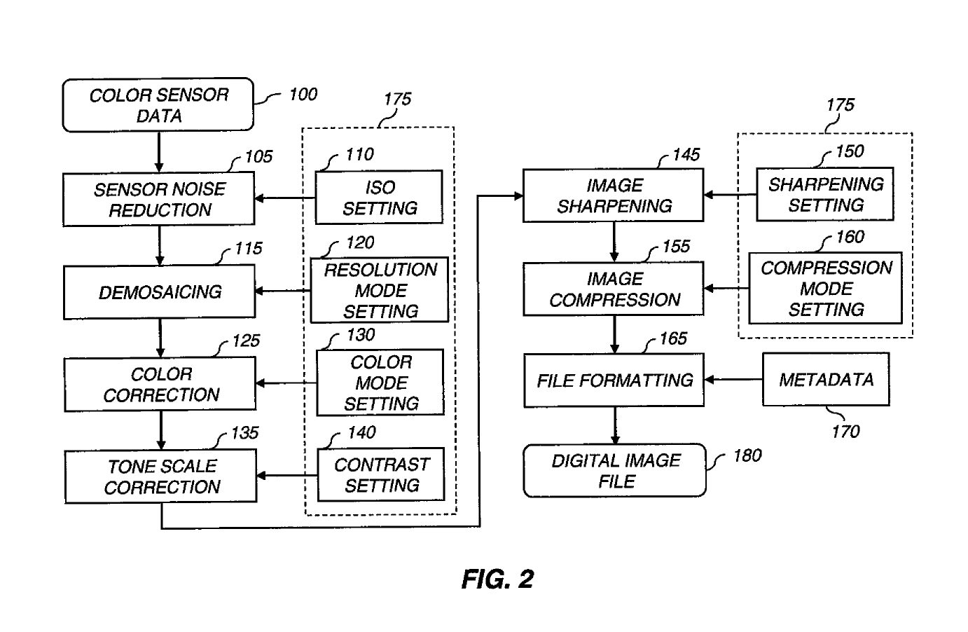

FIG. 2 is a flow diagram depicting image processing operations that can be performed by the processor 20 in the digital camera 10 (FIG. 1) in order to process color sensor data 100100 from the image sensor 14 output by the ASP and A/D converter 16. In some embodiments, the processing parameters used by the processor 20 to manipulate the color sensor data 100 for a particular digital image are determined by various user settings 175, which can be selected via the user controls 34 in response to menus displayed on the image display 32.

The color sensor data 100 which has been digitally converted by the ASP and A/D converter 16 is manipulated by a sensor noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting.

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et. al, the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal”, to Cok, the disclosure of which is herein incorporated by reference.

In some embodiments, the user can select between different pixel resolution modes, so that the digital camera can produce a smaller size image. Multiple pixel resolutions can be provided as described in commonly-assigned U.S. Pat. No. 5,493,335, entitled “Single sensor color camera with user selectable image record size,” to Parulski et. al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

### Setting 1 (Normal Color Reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.8 & - 0.40 \\ - 0.20 & - 0.20 & 1.40\end{matrix} ] [ \begin{matrix}{R}_{i n} \\ {G}_{ i n} \\ {B}_{ i n}\end{matrix} ] \qquad ( 1 )$$

### Setting 2 (Saturated Color Reproduction)

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{i n} \\ {G}_{i n} \\ {B}_{i n}\end{matrix} ] \qquad ( 2 )$$

### Setting 3 (De-Saturated Color Reproduction)

$$[ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{i n} \\ {G}_{ i n} \\ {B}_{i n}\end{matrix} ] \qquad ( 3 )$$

### Setting 4 (Monochrome)

$$[ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{ i n} \\ {G}_{i n} \\ {B}_{i n}\end{matrix} ] \qquad ( 4 )$$

In other embodiments, a three-dimensional lookup table can be used to perform the color correction step 125.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables are stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10.

The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et. al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format.

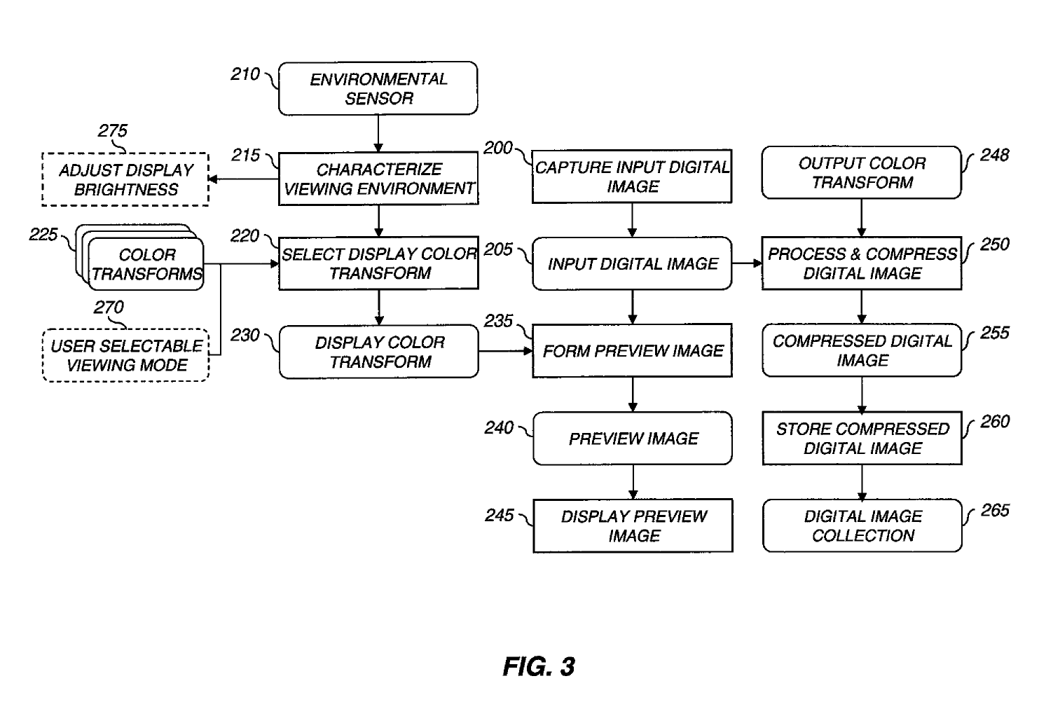

The present invention will now be described with reference to FIG. 3, which outlines a method for providing a preview display with improved visibility under adverse conditions according to a preferred embodiment of the present invention. A capture input digital images block 200 uses the digital camera 10 to capture input digital images 205. In some embodiments, the input digital images 205 are a sequence of digital images which provide a motion video sequence, or video “clip”. In other embodiments, the input digital images 205 are a series of preview images that are captured and displayed on the image display 32 (FIG. 1) for the purpose of composing a still image to be captured, followed by the capture of a high resolution still image.

A characterize viewing environment step 215 is used to characterize the viewing environment using input from an environmental sensor 210. In a preferred embodiment of the present invention, the environmental sensor 210 is used to provide an indication of the light level in the viewing environment where the user will be viewing the image display 32 (FIG. 1). In one embodiment, the environmental sensor 210 can be an auxiliary sensor 42 provided adjacent to the image display 32 that measures the light level incident on the image display 32. In an alternate embodiment, the scene sensing means used during the image capture process to determine a scene brightness level and a corresponding exposure value (EV) to be used during the process of capturing the input digital image 205 can be used as the environmental sensor 210. This approach takes advantage of the fact that the brightness level of the scene being photographed is usually closely related to the ambient light level falling on the image display 32. Commonly, the digital camera's image sensor 14 (FIG. 1) is used as the scene sensing means. Alternately, an auxiliary sensor 42 can be used as the scene sensing means.

Next, a select display color transform step 220 is used to select a display color transform 230 from a set of available color transforms 225 responsive to the characterized viewing environment. In a preferred embodiment, select display color transform step 220 selects a default display color transform having a normal color appearance for cases where the illumination level in the viewing environment is determined to be below a threshold illumination level. For cases where the illumination exceeds the threshold illumination level, an alternate enhanced display color transform is selected to provide improved image visibility under adverse high-glare viewing conditions.

In one embodiment, the enhanced display color transform boosts the image contrast relative to the default display color transform. Preview images created using a higher level of image contrast will have an improved image visibility under high glare viewing conditions. Even though such transforms may not produce “visually pleasing” images due to their exaggerated contrast, they will produce images where the user can more readily discern the position of objects in the preview image, and will therefore enable the user to more accurately compose the desired image. The enhanced display color transform can also be used to adjust other image attributes such as the image brightness and the image colorfulness. The enhanced display color transform can adjust any one of these image attributes, or alternatively can adjust a combination of image attributes. For example, the enhanced display color transform can boost both the image contrast and the image colorfulness relative to the default display color transform.

In alternate embodiments, the enhanced display color transform can apply various special effects to produce an image having improved image visibility. For example, the enhanced display color transform can be used to produce a high-contrast grayscale digital image.

In some embodiments a plurality of enhanced display color transforms can be selected responsive to the characterized viewing environment. For example, display color transforms 230 having increasingly aggressive color enhancements can be selected as the detected illumination level in the viewing environment increases: for viewing environments having moderate illumination levels, a display color transforms 230 having moderate contrast and colorfulness boosts can be selected; for viewing environments having high illumination levels, a display color transforms 230 having large contrast and colorfulness boosts can be selected; and for viewing environments having extremely high illumination levels, a display color transforms 230 that produces a high-contrast grayscale digital image can be selected.

A form preview image step 235 is used to form a preview image 240 by applying the selected display color transform 230 to the input digital image 205. A display preview image step 245 is then used to display the preview image 240 on the image display 32 (FIG. 1) of the digital camera 10 (FIG. 1).

Generally, the default display color transform will be designed to produce high quality preview images when used in ideal viewing conditions. The enhanced display color transforms that are selected by the select display color transform step 220 when adverse viewing conditions are detected would generally produce undesirable results if they were used in ideal viewing conditions, and therefore it would not be appropriate to use them in these cases. However, when preview images 240 are formed using the enhanced display color transforms, they will have improved image visibility relative to the default display color transform when they are viewed under adverse viewing conditions. When the enhanced preview images are viewed under the adverse high-glare viewing conditions, they will generally still be lower in image quality than when the default preview images are viewed in an ideal viewing environment. However, in the adverse viewing conditions, they will have improved image visibility relative to when the default preview images are viewed in the same viewing conditions. This improved image visibility can be an important advantage to the user in many situations. For example, when the user is viewing the preview image during the process of composing an image before capturing a still image, or during the capture of a video clip, the enhanced preview image can provide the user with an improved ability to capture the desired region in the scene.

It will generally not be desirable to apply the selected display color transform 230 to the version of the digital image that is to be stored in a digital image collection 265 for later use. Therefore, a separate processing path is provided to produce output images for storage in the digital image collection 265. A process and compress digital image step 250 is used to process the input digital image 205 to produce a compressed digital image 255.

The process and compress digital image step 250 will generally include the application of a number of image processing operations including color processing and image compression. The color processing will generally involve the application of an output color transform 248. In one embodiment, the output color transform can be identical to a default display color transform that is used to form the preview image 240 for use in ideal viewing conditions. This would be appropriate for the case when the image display 32 (FIG. 1) has characteristics similar to standard video displays (e.g., video displays designed to view standard sRGB images). In other embodiments, the output color transform 248 can be a null transform for the case where the input digital image is already in the desired color space for the compressed digital image 255.

In a preferred embodiment, the process and compress digital image step 250 includes a JPEG compression step which is used to produces compressed digital images 255 in the well-known JPEG format. A store compressed digital image step 260 is then used to store the compressed digital image 255 in the digital image collection 265.

In an alternate embodiment of the present invention, an optional adjust display brightness step 275 is used to adjust the brightness of the image display 32 (FIG. 1) responsive to the characterized viewing environment. For example, in low-brightness viewing environments, the adjust display brightness step 275 can set the image display 32 to use a low brightness level to mitigate the eye fatigue that can result from viewing overly bright displays. Then in high-brightness viewing environments the adjust display brightness step 275 can set the image display 32 to use a high brightness level to help overcome the effects of high levels of viewing flare. Adjusting the display brightness in this manner works together with the selection of the display color transform 230 to provide improved image visibility of the preview image 240.

The mechanism for adjusting the display brightness using the adjust display brightness step 275 will be a function of the type of image display 32 (FIG. 1) used in the digital camera 10 (FIG. 1). LCD image displays are one common type of image display 32. LCD image displays generally include a backlight which is used to provide light which is then modulated by the LCD pixels. In this case, the adjust display brightness step 275 can adjust the light level of the backlight, for example by adjusting a duty cycle parameter. OLED image displays have also been used in digital cameras. In this case, the adjust display brightness step 275 can be used to directly modify the maximum brightness of the OLED pixels.

In one embodiment of the present invention, the select display color transform step 220 is also responsive to an optional user selectable viewing mode 270. In this case, user controls 34 (FIG. 1) associated with the user interface of the digital camera 10 (FIG. 1) can be used by a user to select the user selectable viewing mode 270. For example, one user selectable viewing mode 270 can be selected when the user desires that the display color transform 230 be automatically selected based on the characterized viewing environment. Another user selectable viewing mode 270 can be selected when the user desires to turn this feature off and always use the default display color transform. A third user selectable viewing mode 270 can be selected when the user desires to always use an enhanced preview color transform.

The user selectable viewing mode 270 can also be used to select between modes where the enhanced display color transforms have various levels of aggressiveness, or use different color enhancement styles. For example, one user may prefer enhanced display color transforms that increase the contrast and another user may prefer enhanced display color transforms that produce grayscale preview images.

In an alternate embodiment, the select display color transform step 220 can be used to manually select the display color transform 230 responsive to the user selectable viewing mode 270 without using any input from the environmental sensor 210. This could be useful for cases where the user wants to maintain full control, or where the user does not prefer the results obtained using the automatically selected display color transform. In one embodiment, a user interface control such as a button on the back of the digital camera can be used to manually specify whether or not to use a display color transform 230 having enhanced contrast and colorfulness. For example, when the button is not pressed a default device color transform is used. But when the user is in a high glare viewing environment, the user can press the button to select the enhanced display color transform.

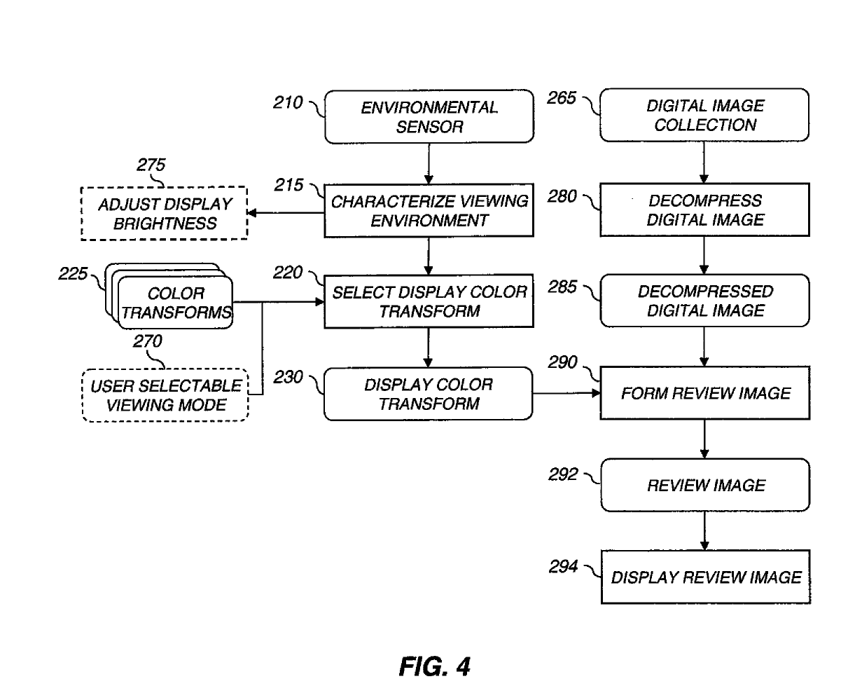

In addition to capturing digital images, digital cameras are also commonly used in a review mode to review previously captured digital images that are stored in the image memory 30 (FIG. 1) as part of the digital image collection 265 (FIG. 3). FIG. 4 shows a flow chart illustrating how the method of the present invention can be utilized when the digital camera 10 is being used in an image review mode. A decompress digital image step 280 is used to decompress a decompressed digital image 285 from the digital image collection 265. As in the image preview mode that was described relative to FIG. 3, the characterize viewing environment step 215 is used to characterize the viewing environment responsive to a signal from the environmental sensor 210. The select display color transform step 220 then selects a display color transform 230 from a set of available color transforms 225. A form review image step 290 is then used to apply the display color transform 230 to the decompressed digital image 285, forming a review image 292. A display review image step 294 is then used to display the review image 292 on the image display 32 (FIG. 1). As was discussed before, the adjust display brightness step 275 can optionally be used to adjust the brightness of the image display 32 responsive to the characterized viewing environment. Additionally, the select display color transform step 220 is optionally responsive to the user selectable viewing mode 270.

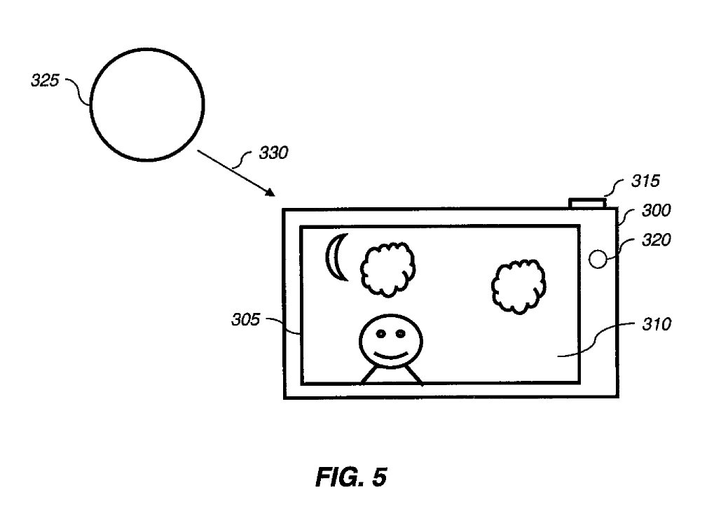

FIG. 5 is a diagram showing features of a digital camera 300 that are relevant to the present invention. The digital camera 300 has an image capture button 315 for initiating image capture, and an image display 305 that can be used to display preview images 240 (FIG. 3) and review images 292 (FIG. 4) according to the method of the present invention. The image display 305 can also be used to display various user interface elements such as menus and buttons. In a preferred embodiment the image display 305 will be a LCD display screen having a touch sensitive overlay that enables a user to interact with the user interface by touching the image display 305. There are many ways to form touch screen overlays known to those skilled in the art. In one embodiment of the present invention, the touch sensitive overlay uses capacitive touch screen technology. Other types of touch screens that can be used in accordance with the present invention include those that use resistive technology, infrared technology or surface acoustic wave technology. In some embodiments, various user interface elements such as buttons, joysticks and dials (not shown) may be provided to interact with the user interface elements.

A displayed digital image 310 is shown, which can be either a preview image 240 or a review image 292 formed according to the methods described earlier with reference to FIGS. 3 and 4. An auxiliary environmental sensor 320 is shown adjacent to the image display 305 for measuring an illumination level of the ambient light 330 falling on the image display 305 from one or more light sources 325. The light source 325 can be the sun or some other light source. In many viewing environments a plurality of light sources will contribute to the ambient light 330 falling on the image display 305. As described above, some embodiments of the present invention use the image sensor 14 (FIG. 1) as the environmental sensor rather than the separate auxiliary environmental sensor 320 shown in this configuration.

In some embodiment of the present invention, the preview image 240 (FIG. 3) is displayed on the image display 305 in response to a user partially depressing the image capture button 315. While the image capture button 315 is partially depressed, the displayed preview image is updated in real time by continuing to capture new input digital images 205 (FIG. 3) and processing them using the selected display color transform 230 (FIG. 3) to determine updated preview images 240. In this way, the user is enabled to adjust the image composition until a desired image composition is achieved.

Next, when the user fully depresses the image capture button 315 the input digital image 205 is recorded in the processor-accessible memory. The recorded digital image may be formed from the same input digital image 205 that was used to produce the most recent preview image 240, or alternately a new input digital image 205 may be captured and recorded in response to the user fully depressing the image capture button 315.

In some embodiments, after the image capture button 315 has been fully depressed and the input digital image 205 has been recorded, the recorded digital image is automatically displayed on the image display 305 for a period of time to allow the user to review the captured digital image. The user can choose to perform actions such as deleting or tagging the captured digital image by interacting with the user interface appropriately. The displayed digital image can be considered to be a review image 292 (FIG. 4). In some embodiments, the review image 292 is processed using a selected display color transform 230 responsive to a signal from the environmental sensor 210. In other embodiments the review image 292 may be displayed on the image display 305 without using the display color transform 230. Alternately, the user can be provided with a choice of whether to apply the display color transform 230 by providing a user selectable viewing mode.

When the method of the present invention is applied to a digital video camera, or to a digital still camera being used in a video capture mode, the preview image 240 is continuously updated to provide the user with an indication of the digital video images that are being captured and stored in a digital video file. The digital video file is a type of digital image collection 265. In some embodiments, the preview image 240 is updated to display each frame of the captured digital video. In other embodiments, only a subset of the frames are used to form preview images 240. For example, preview images 240 may be formed for only every second frame of the digital video.

In one embodiment of the present invention the set of available color transforms 225 includes color transforms having different contrast or colorfulness characteristics. There are many ways for adjusting the contrast of a digital image that are known to those skilled in the art. One way to increase the contrast of a digital image that can be used in accordance with the present invention is to take a subset of the code values in the input digital image 205 and stretch them to fill the code value range of the image display 305. Mathematically, this operation can be expressed by the equation:

CVₒᵤₜ=Clip(mCVᵢₙ+b,0,255) (5)

where CVᵢₙ is a code value of the input digital image 205, CVₒᵤₜ is a code value of the contrast boosted digital image, m is a slope parameter related to the image contrast, b is an offset parameter related to the image brightness and Clip(x, 0, 255) is a function which clips a value to be within the range 0 to 255. In this example, it is assumed that the image display 305 accepts code values in the range of 0 to 255, although it will be clear to one skilled in the art that Eq. (5) can be generalized to use any display code value range.

The slope parameter m and the offset parameter b in Eq. (5) can be related to the subset of input code value that are to be stretched to fill the code value range of the image display 305 using the following equations:

$$\begin{matrix}m = \frac{255}{Max - Min} & ( 6 ) \\ b = - m \cdot Min & ( 7 )\end{matrix}$$

where Min and Max are the minimum and maximum input code values in the subset of input code values, respectively.

There are many ways for adjusting the colorfulness of a digital image that are known to those skilled in the art. One way to increase the colorfulness of a digital image that can be used in accordance with the present invention is to apply a matrix transformation to the code values in the input digital image 205. One such matrix transformation is given by the equation:

$$[ \begin{matrix}{R}_{out} \\ {G}_{out} \\ {B}_{out}\end{matrix} ] = {M}_{C} \cdot [ \begin{matrix}{R}_{i n} \\ {G}_{i n} \\ {B}_{i n}\end{matrix} ] \qquad ( 8 )$$

where Rᵢₙ, Gᵢₙ and Bᵢₙ are red, green and blue code values for a pixel of the input digital image 205, respectively, Rₒᵤₜ, Gₒᵤₜ and Bₒᵤₜ are red, green and blue code values for a corresponding pixel of the colorfulness enhanced digital image, and M_{C} is a colorfulness matrix. One form of a colorfulness matrix that can be used in accordance with the present invention is given by:

$${M}_{C} = [ \begin{matrix}{K}_{1} & {K}_{2} & {K}_{2} \\ {K}_{2} & {K}_{1} & {K}_{2} \\ {K}_{2} & {K}_{2} & {K}_{1}\end{matrix} ] \qquad ( 9 )$$

where K₁ and K₂ are matrix coefficients. In one embodiment of the present invention, the matrix coefficients can be related to a saturation parameter S using the following equations:

K₁=1+2S/3 (10)

K₂=−S/3 (11)

Note that a clipping step like that shown explicitly in Eq. (5) is implicitly present in the Eq. (8), as well as the transforms described in the following equations, in order to keep the transformed code values from exceeding the allowed range of transformed code values.

A third type of color transform is a grayscale conversion transform that converts a color input digital image 205 to a grayscale (monochrome) digital image. There are many types of grayscale conversion transforms that are known to those skilled in the art. One form of grayscale conversion transform that can be used in accordance with the present invention is represented by the equation:

$$[ \begin{matrix}{R}_{out} \\ {G}_{out} \\ {B}_{out}\end{matrix} ] = {M}_{G} \cdot [ \begin{matrix}{R}_{i n } \\ {G}_{i n} \\ {B}_{i n}\end{matrix} ] \qquad ( 12 )$$

where M_{G} is a grayscale conversion matrix. One example of a grayscale conversion matrix that weights the red, green and blue color channels equally is given by:

$${M}_{G} = [ \begin{matrix}1 / 3 & 1 / 3 & 1 / 3 \\ 1 / 3 & 1 / 3 & 1 / 3 \\ 1 / 3 & 1 / 3 & 1 / 3\end{matrix} ] \qquad ( 13 )$$

An alternate grayscale conversion matrix that weights the color channels differently was given in Eq. (4).

The set of color transforms 225 that are selected by the select display color transform step 220 can include color transforms that combine two or more types of color modifications, such as the contrast boosting, colorfulness boosting and grayscale conversion transforms that have been described above. For example, a selected display color transform 230 can include both a contrast boost and a colorfulness boost. Generally, the combined color transforms can be formed by combining the equations for the corresponding individual color transforms. For example, the following equation can be used to combine a contrast boosting color transform and a colorfulness boosting color transform:

$$[ \begin{matrix}{R}_{out} \\ {G}_{out} \\ {B}_{out}\end{matrix} ] = [ \begin{matrix}{K}_{1} & {K}_{2} & {K}_{2} \\ {K}_{2} & {K}_{1} & {K}_{2} \\ {K}_{2} & {K}_{2} & {K}_{1}\end{matrix} ] \cdot [ \begin{matrix}m \cdot {R}_{i n} + b \\ m \cdot {G}_{i n} + b \\ m \cdot {B}_{i n} + b\end{matrix} ] \qquad ( 14 )$$

Similarly, the following equation can be used to combine a grayscale conversion color transform with a contrast boosting color transform:

$$[ \begin{matrix}{R}_{out} \\ {G}_{out} \\ {B}_{out}\end{matrix} ] = [ \begin{matrix}m & 0 & 0 \\ 0 & m & 0 \\ 0 & 0 & m\end{matrix} ] \cdot [ \begin{matrix}1 / 3 & 1 / 3 & 1 / 3 \\ 1 / 3 & 1 / 3 & 1 / 3 \\ 1 / 3 & 1 / 3 & 1 / 3\end{matrix} ] \cdot [ \begin{matrix}{R}_{i n} \\ {G}_{i n} \\ {B}_{i n}\end{matrix} ] + [ \begin{matrix}b \\ b \\ b\end{matrix} ] \qquad ( 15 )$$

In one embodiment of the present invention, the select display color transform step 220 selects between a set of color transforms 225 including three different color transforms depending on an exposure value (EV) provided by the characterize viewing environment step 215 and based on a user selectable viewing mode 270. The following table summarizes the three color transforms:

TABLE 1

| Transform # | Min | Max | S | Grayscale |
|---|---|---|---|---|
| 1 | 0 | 255 | 0 | No |
| 2 | 55 | 233 | 2 | No |
| 3 | 139 | 141 | N/A | Yes |

Transform 1 is a default color transform that does not boost the contrast or colorfulness and does not convert the image to a grayscale representation. This color transform is essentially a null transform and leaves the input digital image unmodified. If this color transform is selected, it is not necessary to even apply the color transform to the input digital image 230 since the preview image 240 will be equal to the input digital image 230. Transform 2 is a color transform that imparts a moderate contrast boost and a moderate colorfulness boost. Transform 3 is a color transform that imparts a large contrast boost and converts the image to a grayscale representation.

A user interface can be provided that allows the user to select between three user selectable viewing modes 270. In a first user selectable viewing mode 270, Transform 1 is always selected so that a default color transform is always applied, independent of the signal from the environmental sensor 210.

In a second user selectable viewing mode 270, the select display color transform step 220 selects between Transform 1 and Transform 2 depending on the measured EV value. Table 2 shows example EV ranges that are used by the select display color transform step 220 to select the display color transform 230. In this mode, a display color transform 230 incorporating a contrast boost and a colorfulness boost, and therefore having improved image visibility, is selected for high EV values that generally correspond to adverse high-flare viewing conditions.

TABLE 2

| EV Range | Transform # |
|---|---|
| 0-8 | 1 |
| >8 | 2 |

In a third user selectable viewing mode 270, the select display color transform step 220 selects between Transform 1 and Transform 3 depending on the measured EV value. Table 3 shows example EV ranges that are used by the select display color transform step 220 to select the display color transform 230. In this mode, a high-contrast grayscale transform having improved image visibility is selected for high EV values that generally correspond to adverse high-flare viewing conditions.

TABLE 3

| EV Range | Transform # |
|---|---|
| 0-8 | 1 |
| >8 | 3 |

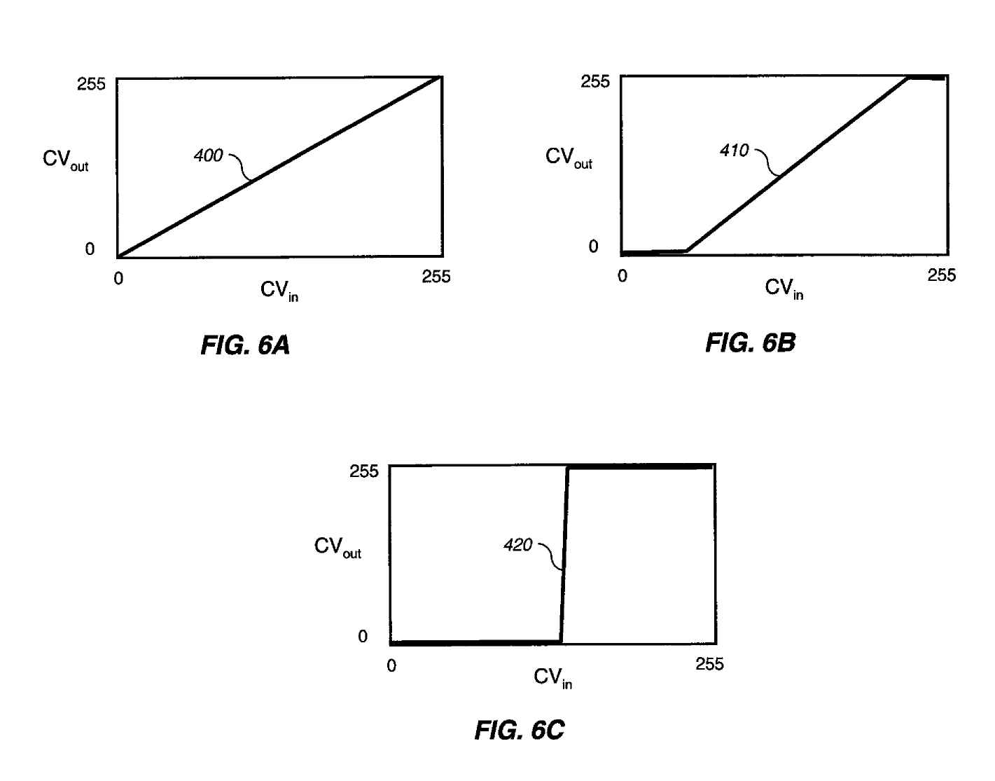

In some embodiments the display color transform 230 can be implemented using a series of one-dimensional look-up tables and matrix transformations. For example, the contrast boosting transformation can be implemented using a one-dimensional look-up table that transforms input code values to contrast boosted code values. Examples of such look-up tables are shown in FIGS. 6A, 6B and 6C. FIG. 6A shows a first contrast look-up table 400 providing no contrast boost, corresponding to Transform 1 in Table. 1. FIG. 6B shows a second contrast look-up table 410 providing a moderate contrast boost, corresponding to Transform 2 in Table. 1. FIG. 6C shows a third contrast look-up table 420 providing a large boost, corresponding to Transform 3 in Table. 1. Colorfulness boosting transforms and grayscale conversion transforms can be implemented using 3×3 matrix transformations as shown in Eqs. (8) and (12).

In other embodiments, the display color transform 230 can be implemented using other color transformation types that are well-known to those skilled in the art. For example, the display color transform 230 can be implemented using three-dimensional look-up tables, or by directly evaluating mathematical equations such as the linear contrast boosting function given in Eq. (5).

In an alternate embodiment of the present invention, the set of available color transforms 225 is a continuously varying set of color transforms defined by one or more transform parameters that are functionally related to the characterized viewing environment. For example, functional relationships can be defined relating the Min and Max parameters used in the contrast transform defined in Eqs. (5)-(7) and the saturation parameter S used in the colorfulness boosting transform defined in Eqs. (10)-(11) to an EV value determined by the environmental sensor 210. In this way, as the viewing glare increases, the contrast and colorfulness can be continuously increased to provide improved visibility for the preview and review images.

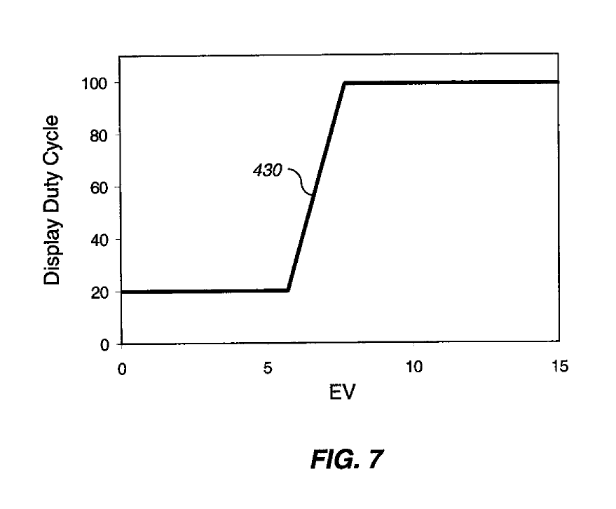

Similarly, the adjust display brightness step 275 can also adjust the brightness of the image display 32 as a function of the EV value. FIG. 7 shows an example of a display brightness adjustment function 430, which adjusts the display brightness as a function of the EV level determined by the environmental sensor 210. In one embodiment, the display brightness of an LCD display is adjusted by adjusting a duty cycle for a display backlight.

The invention has been described in detail with particular reference to certain preferred embodiments thereof, but it will be understood that variations and modifications can be effected within the spirit and scope of the invention.

### PARTS LIST

2 flash
4 zoom lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
26 speaker
28 firmware memory
30 image memory
32 image display
34 user controls
36 display memory
38 wired interface
40 computer
42 auxiliary sensor
44 video interface
46 video display
48 interface/recharger
50 wireless modem
52 radio frequency band
58 wireless network
70 Internet
72 photo service provider
100 color sensor data
105 sensor noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 user settings
180 digital image file
200 capture input digital image step
205 input digital image
210 environmental sensor
215 characterize viewing environment step
220 select display color transform step
225 color transforms
230 display color transform
235 form preview image step
240 preview image
245 display preview image step
248 output color transform
250 process and compress digital image step
255 compressed digital image
260 store compressed digital images step
265 digital image collection
270 user selectable viewing mode
275 adjust display brightness step
280 decompress digital image step
285 decompressed digital image
290 form review image step
292 review image
294 display review image step
300 digital camera
305 image display
310 displayed digital image
315 image capture button
320 auxiliary environmental sensor
325 light source
330 ambient light
400 first contrast look-up table
410 second contrast look-up table
420 third contrast look-up table
430 display brightness adjustment function

1. A digital image capture device having a soft-copy display with improved image visibility under adverse viewing conditions, comprising:
an image sensor for capturing a digital image;
an optical system for imaging a scene onto the image sensor;
a soft-copy display;
a data storage system storing a plurality of color transforms;
an environmental sensing means; and
a processor for performing the steps of:
capturing an input digital image using the image sensor;
selecting a preview color transform from the plurality of color transforms responsive to a signal from the environmental sensing means, wherein a preview color transform that provides improved image visibility relative to a default preview color transform is selected for signals from the environmental sensing means corresponding to adverse viewing conditions;
transforming the input digital image using the preview color transform to form a preview image;
displaying the preview image on the soft-copy display; and
recording the input digital image in a processor-accessible memory without using the preview color transform.

2. The digital image capture device of claim 1 wherein the soft-copy display is an LCD display or an OLED display.

3. The digital image capture device of claim 1 wherein the image sensor is used as the environmental sensing means.

4. The digital image capture device of claim 3 wherein the environmental sensing means determines a brightness level for the scene.

5. The digital image capture device of claim 1 wherein the environmental sensing means detects a light level for ambient light incident on the soft-copy display.

6. The digital image capture device of claim 1 wherein a preview color transform that boosts an image contrast or an image colorfulness is selected when the environmental sensing means detects that the digital image capture device is in a high brightness environment.

7. The digital image capture device of claim 1 wherein a preview color transform that forms a grayscale preview image is selected when the environmental sensing means detects that the digital image capture device is in a high brightness environment.

8. The digital image capture device of claim 1 wherein the selection of the preview color transform is further responsive to a user preference setting.

9. The digital image capture device of claim 8 wherein the user preference setting provides an indication of whether the preview color transform should be modified responsive to the signal from the environmental sensing means.

10. The digital image capture device of claim 8 wherein the user preference setting controls a magnitude of a contrast change or a colorfulness change associated with one or more preview color transforms that are selected for signals from the environmental sensing means corresponding to adverse viewing conditions.

11. The digital image capture device of claim 1 wherein the processor further performs the step of adjusting a brightness of the soft copy display responsive to the signal from the environmental sensing means.

12. The digital image capture device of claim 11 wherein the brightness of the soft copy display is increased for signals from the environmental sensing means corresponding to adverse viewing conditions.

13. The digital image capture device of claim 1 wherein the processor further performs the step of applying an output color transform to the input digital image prior to recording the input digital image in the processor-accessible memory.

14. The digital image capture device of claim 1 wherein the digital image capture device is a digital camera that captures still digital images.

15. The digital image capture device of claim 14 wherein the preview image is displayed on the soft-copy display in response to a user partially depressing an image capture button.

16. The digital image capture device of claim 15 wherein the input digital image is recorded in the processor-accessible memory in response to the user fully depressing an image capture button.

17. The digital image capture device of claim 15 wherein the input digital image is displayed on the soft-copy display without using the preview color transform after the user fully depressing an image capture button.

18. The digital image capture device of claim 1 wherein the digital image capture device is a digital video camera that captures digital videos.

19. The digital image capture device of claim 1 wherein the plurality of color transforms is a continuously varying set of color transforms controlled by one or more transform parameters, and wherein the selection of the preview color transform includes setting parameter values for the one or more transform parameters responsive to the signal from the environmental sensing means.

20. A digital image capture device having a soft-copy display with improved image visibility under adverse viewing conditions, comprising:
an image sensor for capturing a digital image;
an optical system for imaging a scene onto the image sensor;
a soft-copy display;
a data storage system storing a plurality of color transforms; and
a processor for performing the steps of:
capturing an input digital image using the image sensor;
selecting a preview color enhancement transform in response to a user input;
transforming the input digital image using the preview color transform to form a preview image;
displaying the preview image on the soft-copy display, and
recording the input digital image in a processor-accessible memory without using the preview color transform.

21. A digital image display device having a soft-copy display with improved image visibility under adverse viewing conditions, comprising:
a soft-copy display;
an image storage system storing a plurality of digital images;
a data storage system storing a plurality of color transforms;
an environmental sensing means; and
a processor for performing the steps of:
extracting an input digital image from the digital image collection;
selecting a review color transform from the plurality of color transforms responsive to a signal from the environmental sensing means, wherein a review color transform that provides improved image visibility is selected for signals from the environmental sensing means corresponding to adverse viewing conditions;
transforming the input digital image using the review color transform to form a review image; and
displaying the review image on the soft-copy display.
